(19) United States
(12) Patent Application Publication
(10) Pub. No.: US 2002/0069087 A1
(43) Pub. Date: Jun. 6, 2002

(54) System and method for accessing medical or consulting services

(76) Inventors: Grant Douglas Fairley, Mississauga (CA); Gregory Blair Lamb, Mississauga (CA)

Correspondence Address: Joseph R. Keating, Esq, KEATING & BENNETT LLP, Suite 312, 10400 Eaton Place, Fairfax, VA, 22030, US

(21) Appl. No.: 09/780,726

(22) Filed: Feb. 9, 2001

(51) Int. Cl. G06F 17/60

(52) U.S. Cl. 705/2

(57) ABSTRACT

A method of facilitating provision of a medical service using a host server. The method comprises the steps of: verifying the identity of a patient member, the verification performed by the host server; receiving a request for the medical service from the patient member, the request received by the host server; the host server generating a physician approval form based on the request; and transmitting the physician approval form to a registered physician.

### FIELD OF THE INVENTION

The present invention relates to medical or health services and a method for coordinating such services.

### BACKGROUND OF THE INVENTION

Generally, a patient obtains medical or consulting services such as prescription renewals or referrals for medical treatment by appointment with a physician or, in some jurisdictions, a physician-delegate working under the supervision of a physician. For exemplary purposes, the following discussion is directed to methods of obtaining a prescription renewal. Similar methods may apply for other medical services such as prescriptions for topical cream, referrals for medical assessments, consultations or treatment, creating a pager or email message from a patient to a physician, coordinating the authorization of a restricted use class of medications, providing a system for pharmaceutical companies to provide authorized sample medications to patients through physicians, and referrals for testing such as MRI (magnetic resonance imaging), CAT scans, PET scans and mammography scans.

To obtain a prescription renewal, a patient generally makes an appointment with the physician and after consultation, receives the prescription renewal from his or her physician.

This requires that a patient make an appointment, for which he or she may have to wait several days or weeks. The patient must then go to the physician's office for the consultation or appointment. Only after receiving the prescription renewal can the patient go to the pharmacy with the prescription, or have the physician send the prescription to the pharmacy for filling.

This method of prescription renewal suffers from many disadvantages, particularly in the case that a physician can approve such a renewal without the benefit of an appointment with the patient. One such disadvantage is the waiting time that may be required to see the physician, which results in a delay in receiving and filling the prescription renewal. Also, the time of both the patient and the physician is taken up making and attending an appointment. It may be difficult for many patients to leave home or work to attend an appointment. Further, the physician may not have time available for such an appointment and there may be other patients who more urgently require that time. For instance, in an outbreak of influenza, the doctor may not have the time to see a patient.

In an alternative method of renewing a prescription, a patient may telephone the physician to request the prescription renewal. The physician then makes a decision if the prescription can be renewed or if an appointment is necessary. If the prescription can be renewed by telephone, the physician, or physician's assistant, must determine the location and facsimile number of the patient's pharmacy and a facsimile copy of the prescription, complete with all pertinent information, must be sent to the patient's pharmacy.

While an improvement over the first-described method, this method also suffers from many disadvantages. The patient must call the physician in order to make the request for prescription renewal. This can interrupt a busy physician or physician's assistant. For various reasons many doctors refuse to renew a prescription by telephone. Where a physician's assistant answers the phone, he or she must relay the information to the physician to get approval for the renewal of a medication such that the physician receives the information second-hand. Thus the information may be incorrectly relayed. Also, many physicians have extremely busy practices and may not remember each patient's prescribed medication. Therefore, the physician must consult the patient's files to ensure that the prescription renewal is correct. This requires additional time from the physician and the physician's assistant. In some jurisdictions, such as the province of Ontario in Canada, the physician does not receive remuneration for a prescription renewal. Further, there is very little security as it may be difficult to confirm the requesting patient's identity. The physician, or physician's assistant must rely on voice recognition of the patient in order to confirm the requesting patient's identity. This is extremely difficult for a physician with a busy practice. Also, when the patient's physician is away, another physician may temporarily be filling in for the patient's physician and therefore is not likely to have any prior recollection of that patient.

If a physician chooses to renew a prescription by phone, the physician must call the pharmacy and wait to speak with the pharmacist. Then the patient information and prescription instructions must be given. When relaying the information by telephone, there is a risk for errors in how the information is either communicated or understood. In order to create a written record of the prescription order, the physician must then make or dictate notes for the patient file, requiring additional time.

Yet another problem is that the patient's physician may not be available to approve the prescription renewal, for instance if the physician is away from the office for a period of time. An alternative physician may not be available and even so, this requires valuable patient and physician time for a renewal that might not have otherwise required an appointment, Also, in such cases, the physician may not have the patient's medical information or history thus requiring more of the physician's time.

Accordingly, it is an object of the present invention to provide a novel medical or consulting access method and system for more efficient access to medical and consulting services.

In some jurisdictions, it is illegal for medical service providers to share patient information due to privacy laws. Accordingly, in one aspect of the present invention, it is an object to provide a medical record keeping system where a patient's medical records are kept under the control of the patient, are accessible by the patient's medical service providers in order to provide medical services to the patient and to update the records with the services thereon. This system of medical records under the control of the patient should alleviate privacy concerns and legalities.

### SUMMARY OF THE INVENTION

According to one aspect of the present invention, there is provided a method of facilitating provision of a medical service using a host server. The method comprising the steps of: receiving a request from a patient member, the request received by the host server; verifying the identity of the patient member, the verification performed by the host server; and sending the request to a physician member.

According to another aspect of the present invention, there is provided a method of facilitating provision of a medical service using a host server. The method comprises the steps of: verifying the identity of a patient member, the verification performed by the host server; receiving a request for the medical service from the patient member, the request received by the host server; the host server generating a physician approval form based on the request; and transmitting the physician approval form to a registered physician.

According to yet another aspect of the present invention, there is provided a system for facilitating provision of a medical service. The system has: a host server operable to verify the identity of an registered member using a predefined verification protocol; the host server also operable to provide an electronic request form; the host server being further operable to generate a physician approval form based on data provided by a registered patient member; and the host server being further operable to Transmit said physician approval form to a registered physician.

### BRIEF DESCRIPTION OF THE DRAWINGS

The invention will be better understood with reference to the drawings, and the following description, in which:

FIG. 1 is a block diagram of a system for providing a medical service according to a preferred embodiment of the invention.

FIG. 2 is a representation of an electronic membership form according to a preferred embodiment of the invention.

FIG. 3 is a flow chart of a method of becoming a patient member for receiving the medical service according to a preferred embodiment of the invention.

FIG. 4 is a representation of an electronic prescription renewal request form according to a preferred embodiment of the invention.

FIG. 5 is a representation of a physician approval form according to a preferred embodiment.

FIG. 6 is a flow chart of a method of providing a prescription renewal according to an aspect of the present invention.

### DESCRIPTION OF THE PREFERRED EMBODIMENTS

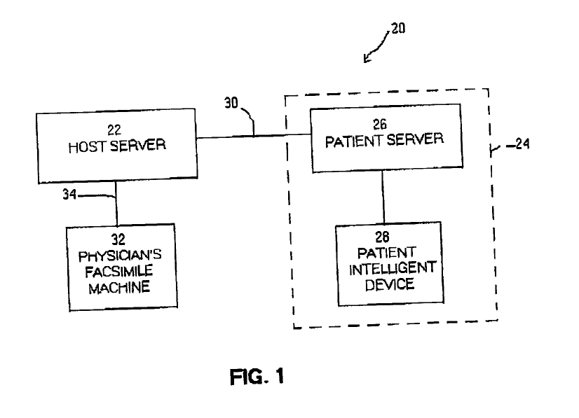

Reference is first made to FIG. 1 to describe a preferred embodiment of a system for providing a medical service, indicated generally by the numeral 20. System 20 has a host server 22 operable to verify the identity of a registered patient using a predefined verification protocol. The host server 22 is also operable to provide an electronic request form. System 20 also includes a patient-input device 24, in communication with the server 22 and operable to receive data to complete said electronic request form. The patient-input device 24 is also operable to transmit the electronic request form to the host server 22 after the electronic request form is completed. When the request form is transmitted from the patient-input device 24, the host server 22 is further operable to generate a physician approval form, such as a prescription renewal, based on the data provided by the registered patient. The server 22 then transmits the physician approval form to a registered physician.

The system 20 will now be described in more detail. The patient-input device 24 includes a patient server 26 and a patient intelligent device 28 such as a personal computer.

The patient intelligent device 28 includes a data entry device such as a keyboard, an output device such as a video card and monitor, a processing unit, a random access memory, and a network interface card for connecting to the patient server 26.

The patient intelligent device 28 is connected to an internet 30 through the patient server 26. The patient server 26 can be any internet service provider.

The host server 22 includes a processing unit, a random access memory, a persistent storage device, an input device, an output device such as a video card and a monitor and a network interface card for connecting to the internet 30. The host server 22 is able to send data to the patient-input device 24 and receive data from the patient-input device 24.

The patient server 26 and the host server 22 are interconnected by the internet 30. Thus, the patient intelligent device 28 is connected through the patient server 26 to the host server 22 by the internet 30. The host server 22 and the patient intelligent device 28 are therefore able to exchange data through the internet 30.

The host server 22 is also connected to a facsimile machine operable to send a facsimile to a physician's facsimile machine 32 through a network 34.

System 20 is operable for providing a medical service such as a prescription renewal, a referral for medical treatment, a referral for testing such as an MRI, CAT, PET, or mammography scan, a prescription provision service for items such as topical creams, or providing access to physicians for consultations using the telephone, the internet, an intranet or videoconference. For the purpose of simplicity, the present description is directed to a method of providing a prescription renewal service, however, similar methods will apply for other medical services.

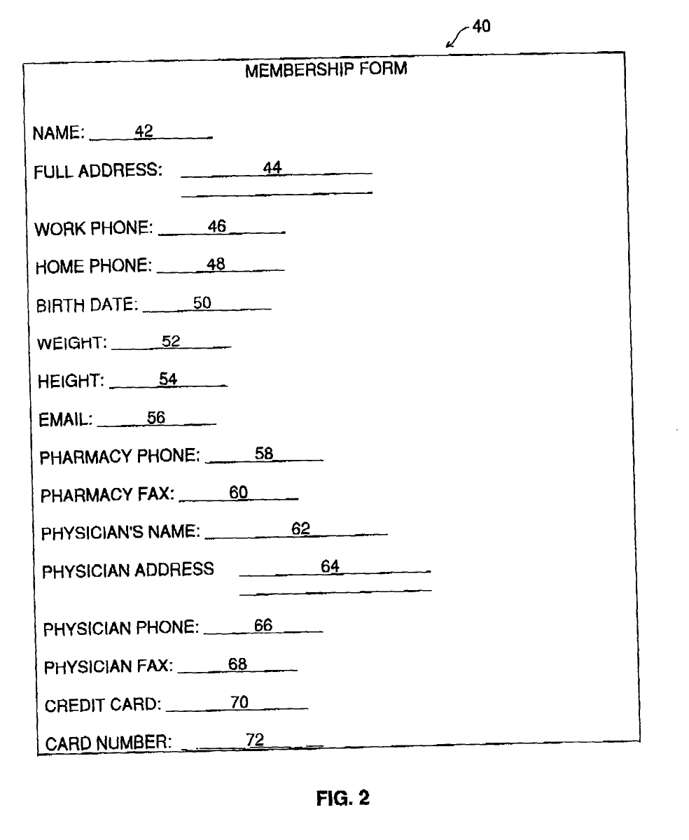

To provide the medical service, a patient first registers as a patient member. Referring now to FIG. 2, a representation of an electronic membership form is indicated generally by the numeral 40. The electronic membership form 40 includes a plurality of electronic data fields. These electronic data fields include, a full name field 42, a full address field 44, a work phone number field 46, a home phone number field 48, a birth date field 50, a weight field 52, a height field 54, an email address field 56, a pharmacy phone number field 58, a pharmacy fax number field 60, a physician's full name field 62, a physician's full address field 64, a physician's phone number field 66, a physician's fax number field 68, a credit card name field 70 and credit card number field 72. All of the data fields 42, 44, 46, 48, 5O, 52, 54, 56, 58, 60, 62, 64, 66, 68, 70, 72 of the electronic membership form 40 can be presented in any suitable user-interface on the patient intelligent device 29.

The full name field 42 represents the full name of the patient. The full address field 44 represents the full address of the patient. It will now be apparent that each of the data fields represents corresponding patient information. The pharmacy phone number field 58, for instance, represents the phone number of the patient's preferred pharmacy.

The host server 22 is operable to store the electronic membership form 40 on it's persistent storage device and make it available to the patient via the internet 30. The host server 22 is further operable to save the electronic membership form 40, after completion by the patient.

Similarly, the patient intelligent device 28 is operable to receive the electronic membership form 40 for completion by the patient. The patient intelligent device 28 is also operable to send the electronic membership form 40 to the host server 22 after completion by the patient.

The host server 22 is further operable to maintain a set of rules associated with the electronic membership form 40. For example, one of the rules is requiring data entry into any or all of the data fields before the host server 22 accepts the electronic membership form 40. For exemplary purposes, each of the data fields of the electronic membership form 40 are required to be completed in the present embodiment. Further, if these data fields are not completed, the host server 22 is operable to return the electronic membership form 40 to the patient intelligent device 28, for completion.

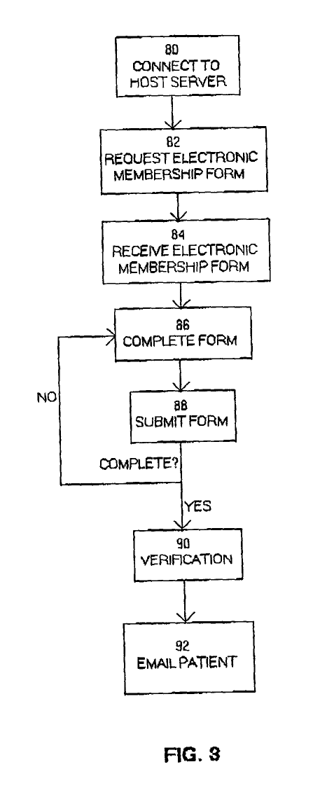

Referring, now to FIG. 3, a method for registering a patient member will now be described with reference to the system 20.

At step 80, the patient uses the patient intelligent device 28 to connect to the host server 22, through the patient server 26 and the internet 30, as described above.

At step 82, the patient requests the electronic membership form 40. Ai step 84, the patient intelligent device 28 receives an electronic membership form 40 with the data fields ready for envy of data by the patient. At step 86, the patient completes each of the data fields by entering data into each of the data fields of the electronic membership form 40. This includes completion of the credit card name field 70 and the credit card number field 72 to indicate that payment of a membership fee is authorized.

The electronic membership form 40 is an HTML document.

At step 88, the patient submits the electronic membership form 40 to the host server 22. If the patient does not complete all of the required data fields of the electronic membership form 40, then the host server 22 returns the form 40 to the patient intelligent device 28 and returned to step 86. For the purpose of the present example, when all of the data fields are completed, the host server 22 accepts the electronic membership form 40 and the information is stored in a database.

At step 90, the data in the completed data fields is verified by checking the patient's phone number, address and the patient's physician and physician's address. To verify this information, the patient, pharmacy and physician phone numbers and addresses are confirmed using an independently published source such as a telephone and address directory. The physician is then notified that the patient has joined the service. The patient is also contacted by telephone and email to confirm that membership was requested, the patient's credit card is checked to ensure that it is valid the patient's credit card is debited a membership fee. The database is updated accordingly.

If all of the data contained in the data fields is verified and determined to be correct, the patient is then notified by electronic mail that their membership request has been accepted at step 92. Further, the patient, now a patient member, is given a unique patient member identification and password to access a patient member section of the website. The host server 22 then updates the database accordingly.

If the data contained in the data fields is determined to be incorrect, the patient is notified by email that their membership request has been denied with the reason(s) for the denial at step 92.

A physician becomes a physician member by similarly completing a physician membership form. It will be understood that the data fields required for a physician to become a physician member can be different from the data fields required to be completed for a patient to become a patient member. For example, a physician membership form may not include a credit card name data field or a credit card number data field. Alternatively, a physician can become a physician member using other methods of providing required information, such as requesting, completing, and submits a facsimile request form. The physician phone number and address is then verified using an independently published source such as a telephone directory and the physician agrees to join. The physician's medical license is checked in their jurisdiction with the appropriate governing body, for example, in the Province of Ontario, Canada, the physician's license would be confirmed with the Ontario College of Physicians and Surgeons.

Similarly, a pharmacy can become a pharmacy member by having a pharmacist complete a pharmacy member form. Again, the data fields required to be completed for a pharmacy to become a member can differ from those fields for a physician or a patient. Also, a pharmacy can become a pharmacy member using other methods of providing required information, such as requesting, completing, and submitting a facsimile request form. The phone number and address of the pharmacy is verified using an independently published source such as a telephone directory. Similar to the physician, the pharmacist must agree to join and the pharmacist's license is verified for that jurisdiction for example, in the Province of Ontario, Canada, the pharmacist's license would be confirmed with the Ontario College of Pharmacists.

It will now be apparent that the host server 22 is operable to maintain a plurality of patient members, physician members, and pharmacy members.

The system 20 is operable to process at least one electronic medical service request, such as a prescription renewal request, a referral for medical treatment, a referral for testing or a prescription provision.

While the system 20 is operable for providing a medical service, the present embodiment is directed to a method of providing a prescription renewal service. It will be understood that similar methods to those herein described for a prescription renewal, will apply for other medical services.

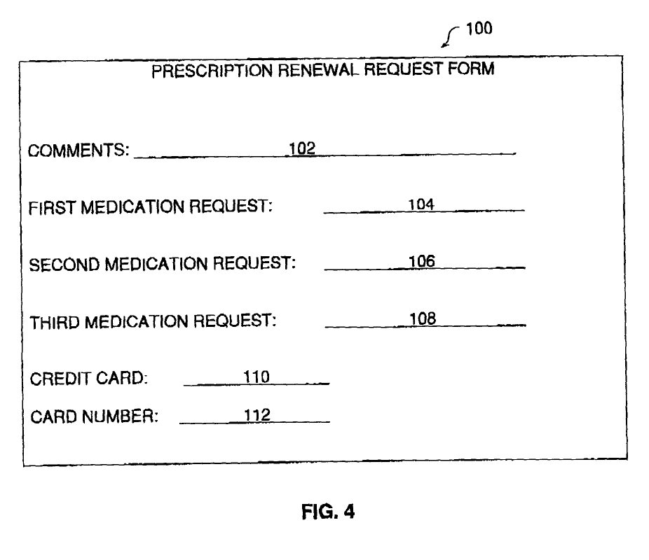

Referring now to FIG. 4, a representation of an electronic prescription renewal request is indicated generally at 100. The electronic prescription renewal request 100 includes a plurality of electronic data fields. For exemplary purposes, the present data fields include a comment field 102, a first medication request field 104, a second medication request field 106, a third medication request field 108, a credit card name field 110, and a credit card number field 112. All of the fields 102, 104, 106, 108, 110, 112 of the electronic prescription renewal request form 100 can be presented in any suitable user-interface on the patient intelligent device 28.

Information is entered in the comment field 102 by the patient member and represents any information that the patient member wishes to relay to a physician. Information is entered in the first medication request field 104 by the patient member and represents a first medication requested for prescription renewal. Similarly, information is entered in the second and third medication request fields 106, 108, respectively, by the patient member and this information represents a second and third medication requested for prescription renewal. Information is entered in the credit card name field 110 by the patient member and represents a patient's preferred credit card, for payment of service. Similarly, information is entered in the credit card number field 112 by the patient member and represents a credit card number of the patient's preferred credit card.

The host server 22 is operable to store the electronic prescription renewal request 100 in any suitable format, such as database. The host server 22 is also operable to make the electronic prescription renewal request 100 available on the patient intelligent device 28, for completion by a patient member and to receive the prescription renewal request 100 from the member intelligent device 28, after completion by the patient member.

The host server 22 is further operable to maintain a set of rules associated with the electronic prescription renewal request form 100. For example, one of the rules is requiring data entry into any or all of the data fields before the host server 22 accepts the prescription renewal request form 100 for processing. For exemplary purposes, each of the data entry fields in the present embodiment are required to be completed except for the second and third medication request fields 106, 108, respectively Further, if the required data fields are not completed the host server 22 is further operable to return the electronic prescription renewal request form 100 to the patient intelligent device 28, for completion.

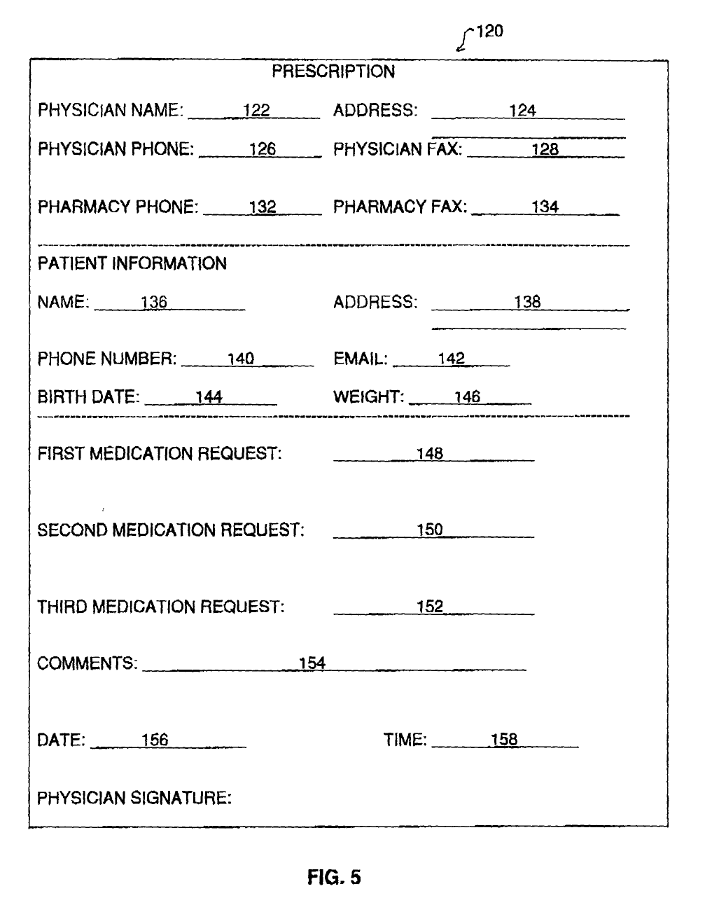

Referring to FIG. 5, using the data from each of the data fields, entered by the patient member when filling out the electronic membership form 40 and the electronic prescription renewal request form 100, the host server 22 is operable to generate an electronic prescription renewal. An exemplary representation of the electronic prescription renewal is indicated generally by the numeral 120.

The electronic prescription renewal 120 includes a plurality of data fields that are automatically entered by the host server 22. These data fields include a physician's name field 122, a physician's address field 124, a physician's phone number field 126, a physician's facsimile number field 128, a pharmacy phone number field 132, a pharmacy facsimile number field 134, a patient name field 136, a patient address field 138, a patient phone number field 140, a patient electronic mail address field 142, a patient age field 144, a patient weight field 146, a first requested medication field 148, a second requested medication field 150, a third requested medication request field 152, a comments field, 154, a date field 156, and a time field 158.

As previously described, each data field represents corresponding data entered by the patient and saved by the host server 22. The host server 22 enters this data on the prescription renewal 120, as shown in FIG. 5. Other information, including physician and pharmacy instructions, is also provided on the prescription renewal 120.

The host server 22 is also operable to send the prescription renewal 120 to the physician's facsimile machine 32, thereby making the prescription renewal 120 available in paper format for the physician requested by the patients.

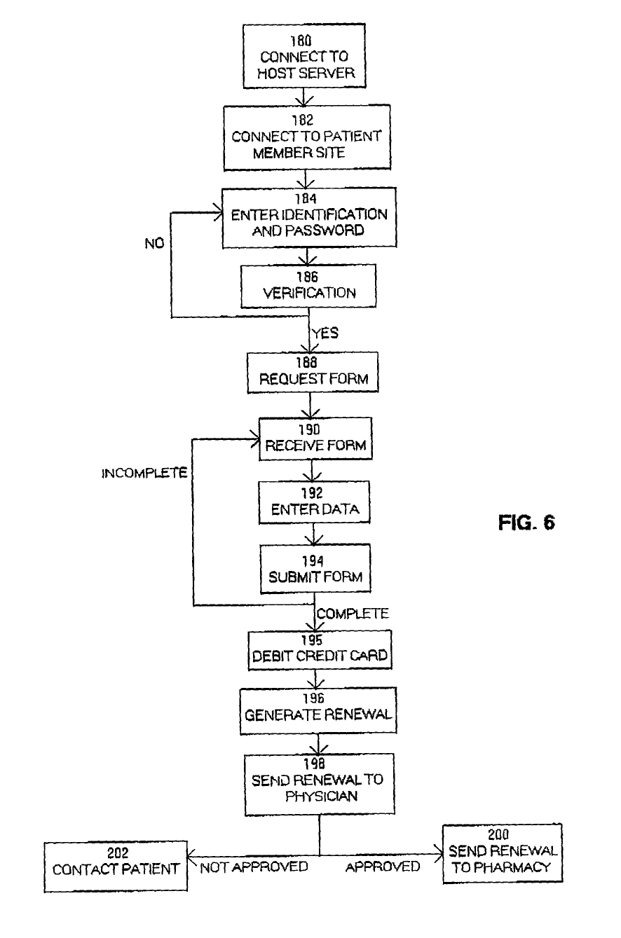

A method for processing a prescription renewal request will now be discussed with reference to the foregoing and to the flow chart of FIG. 6. For the purposes of assisting in explaining the present embodiment, the electronic prescription renewal request form 100 and the prescription renewal 120 of FIGS. 4 and 5 respectively will be referred to.

At step 180, the patient member uses the patient intelligent device 28 to connect to the host server 22, through the patient server 26 and the internet 30, as described above.

At step 182, the patient member goes to the patient member section of the website. The patient member is then prompted for the membership identification number and the password, which was provided for the patient member, as described above. The patient member then enters the membership identification number and password into the data entry device of the patient intelligent device 28.

At step 186, the host server 22 verifies the identification number and the password. The entered patient member identification and password are checked against a list of the patient member identifications and passwords stored on the persistent storage device of the host server 22 and, if verified, the patient member is granted access to the patient member section of the website. If the patient member identification and password is not on the list of identifications and passwords, the host server 22 returns to step 182. For the purpose of the present example, the patient member identification and password is verified and the patient member is granted access to the patient member section of the website.

At step 188, the patient requests the electronic prescription renewal request form 100 and the host server 22 makes the electronic prescription renewal request form 100 available to the patient intelligent device 28 at step 190.

At step 192, the patient member enters data into the data entry fields of the prescription renewal request form 100. For the purpose of the present example, the patient member enters data into each of the medication request fields, 104, 106 and 108, therefore requesting prescription renewal of three medications.

At step 194, the patient member submits the electronic prescription renewal request form 100 with the entered data to the host server 22. If the patient does not enter data into all of the required data fields of the request form 100, then the host server 22 returns the electronic prescription renewal to the patient intelligent device 28 and returns to step 190.

For the purpose of the present example, the patient member has completed the electronic prescription renewal request form 100 and has requested prescription renewal of three medications.

At step 195, the patient's credit card is debited a prescription renewal request fee.

At step 196, the host server 22 generates the prescription renewal 120, and sends the prescription renewal 120 to the physician's facsimile machine 32 where it is printed in paper format. The prescription renewal 120 includes all of the data as previously described, for the convenience of the physician.

At step 198, the prescription renewal 120 is received by the physician and the physician approves the prescription renewal 120 by writing dosage information and any other instructions under each of the requested medication fields 148, 150, 152, and by signing and dating the renewal 120.

At step 200, the physician sends the prescription renewal 120 to a pharmacy's facsimile machine using the pharmacy facsimile number provided in the pharmacy facsimile number field 134. If the physician does not approve the prescription renewal 120, The physician does not send the prescription renewal 120 to the pharmacy's facsimile machine and the physician's office contacts the patient member to report the declined prescription and to schedule an office appointment if necessary, using the patient phone number provided in the patient phone number field 140.

At step 210, the pharmacy fills the prescription for the patient member to pick up or for delivery to the patient member and contacts the patient or waits for the patient to contact the pharmacy.

While the embodiment discussed herein is directed to a particular implementation of the present invention, it will be apparent that variations to this *embodiment are within the scope of the invention. For example, the patient intelligent device described herein is a personal computer but other intelligent devices such as a personal digital assistant can be used.

Referring to the electronic membership form 40, there can be other data fields or different data fields provided, as desired or required. Also, there can be data fields that are not required to be completed by the patient in order to be accepted as a patient member.

If data is not entered into all of the data fields of the electronic membership form 40, the host server 22 can return to step 86 of FIG. 3, as described, or can, for instance, prompt the patient for the required information that was not included. Alternatively, the host server 22 can make the partially completed form available to the patient with a message to inform the patient which data fields are required. Also, at step 90 of FIG. 3, any other information required can be confirmed or verified.

As previously discussed, the above-described embodiment was directed to a system and method of providing a prescription renewal, however other medical services can be provided in a similar manner. These can include referral for medical assessments, consultations or treatment such as a referral to an orthopedic specialist, referral for neurology treatment, cancer treatment, dermatology, urology or other medical treatment. A referral for testing such as an MRI, CAT, PET, or mammography scan, a prescription provision service for items such as topical creams, or access to physicians for consultations using the telephone, the internet, an intranet or videoconference can also be provided. Further, provision of other services such as creating a pager or email message from a patient to a physician, coordinating the authorization of a restricted use class of medications or providing a system for pharmaceutical companies to provide authorized sample is also contemplated.

The host server 22 is therefore operable to provide electronic request forms for such services and to generate a physician approval form for each service. In the above-described embodiment, The prescription renewal 120 is the physician approval form.

It is contemplated that there may be offered different medical services dependent on the information provided by the patient. For example, an electronic membership form 40 may include other data fields that, if completed, allow the patient to access different medical services. In the instance that a client does not enter data into each of the data fields provided, certain medical services may not be provided. The host server 22 can be further operable to maintain a set of privileges associated with each patient member and to determine these privileges for each patient member. For example, these privileges can include access to certain electronic request forms.

The host server 22 can also be operable to direct a renewal or other document to an appropriate physician, if for example, a patient's physician is not available. Also, other information can be provided for the convenience of the physician. For example, the patient's medical history or history of prescribed medication can be saved in a database and made available to the physician when a request is made by the patient. Further, the database of the patient's medical history or history of prescribed medication can be available to the patient at any time and can be made available, with the consent of the patient, to any physician or pharmacist. Thus this information can then available for the patient.

Also, the physician can receive remuneration for the review of a request and approval of a prescription or other service. A fee payment for the medical service can be collected from the patient using the patient's credit card information provided. A physician can be remunerated using a portion of the fee payment collected.

It will be understood that any person using the internet can apply to become a patient member. Membership can, however, be limited depending on a set of rules. For example, there may be a minimum age requirement, membership of the patient's physician or pharmacy may be required or other restrictions. The host server 22 is therefore operable to maintain these rules for membership.

Similar to the electronic membership form 40, there may be other data fields provided on the electronic prescription renewal request form 100. Also, data fields on the prescription renewal 120 can differ.

Also, the credit card name field 70 and credit card number field 72 may not be included on the electronic membership form 40. The patient can be prompted to enter such data by the host server 22 after submission of the electronic membership form. Similarly, the credit card name field 110 and the credit card number field 112 may not be included on the electronic prescription renewal form 100. Again, the patient may be prompted for such information.

It is also contemplated that other secure methods of communication or delivery can be made available, for instance, the prescription renewal 120 can be sent to a physician's computer, where possible. The renewal can be signed and filled in by a physician using an electronic signature and sent in electronic form to a computer at the pharmacy.

We claim:

1. A method of facilitating provision of a medical service using a host server, said method comprising the steps of:
receiving a request from a patient member, said request received by said host server;
verifying the identity of said patient member, said verification performed by said host server; and
sending the request to a physician member.

2. A method of facilitating provision of a medical service according to claim 1 wherein said method further comprises the step of receiving an approval from said physician.

3. A method of facilitating provision of a medical service according to claim 2 wherein said method further comprises the step of sending an approved request to a third party for fulfillment.

4. A method of facilitating provision of a medical service according to claim 3 wherein said third party is a pharmacy.

5. A method of facilitating provision of a medical service according to claim 1 wherein said step of verifying the identity of said patient member includes the steps of checking a member identification and password against a set of patient member identifications and passwords.

6. A method of facilitating provision of a medical service according to claim 1 wherein said method further comprises the step of debiting a credit card a predetermined sum of money.

7. A method of facilitating provision of a medical service using a host server, said method comprising the steps of:
verifying the identity of a patient member, said verification performed by said host server;
receiving a request for the medical service from said patient member, said request received by said host server;
said host server generating a physician approval form based on said request; and
transmitting said physician approval form to a registered physician.

8. A method of facilitating provision of a medical service according to claim 7 wherein said method further comprises the step of receiving an approval from said physician.

9. A method of facilitating provision of a medical service according to claim 8 wherein said method further comprises the step of sending an approved request to a third party for fulfillment.

10. A method of facilitating provision of a medical service according to claim 7 wherein said third party is a pharmacy.

11. A method of facilitating provision of a medical service according to claim 7 wherein said step of verifying the identity of said patient member includes the steps of checking a member identification and password against a set of patient member identifications and passwords.

12. A method of facilitating provision of a medical service according to claim 7 wherein said method further comprises the step of debiting a credit card a predetermined sum of money.

13. A method of facilitating provision of a medical service according to claim 12 wherein said step of verifying the identity of a patient member is followed by the step of making a request form available to the patient member.

14. A method of facilitating provision of a medical service according to claim 13 wherein said method further comprises the step of determining a set of privileges associated with said patient member.

15. A method of facilitating provision of a medical service according to claim 13 wherein said privileges include the approval to have the request form made available.

16. A method of facilitating provision of a medical service according to claim 15 wherein said request form is one of a prescription renewal form, a new prescription form, a medical treatment referral form, and a medical testing form.

17. A method of facilitating provision of a medical service according to claim 7 wherein said request is one of an electronic prescription renewal request, an electronic prescription request, a medical treatment request, and a medical testing request.

18. A method of facilitating provision of a medical service according to claim 7 wherein said request form is represented in HTML format.

19. A method of facilitating provision of a medical service according to claim 10 wherein said request form is represented in XML format.

20. A system for facilitating provision of a medical service, said system having:
a host server operable to verify the identity of an registered member using a predefined verification protocol;
said host server also operable to provide an electronic request form;
said host server being further operable to generate a physician approval form based on data provided by a registered patient member; and
said host server being further operable to transmit said physician approval form to a registered physician.

21. A system for facilitating provision of a medical service according to claim 13 wherein said verification protocol includes a personal identification number.

22. A system for facilitating provision of a medical service according to claim 14 wherein said electronic request form is provided via the internet.

23. A system for facilitating provision of a medical service according to claim 15 wherein said electronic request form is represented in HTML format.

24. A system for facilitating provision of a medical service according to claim 15 wherein said electronic request form is represented in XML format.

25. A system for facilitating provision of a medical service according to claim 13 wherein said physician approval form is transmitted via facsimile.

26. A method of facilitating sharing of medical records of a patient between medical service providers, said method comprising the steps of;
storing said records on a remotely accessible server where said records are under the control of said patient;
providing access to said records to said providers on authorization of said patient; and
updating said records for medical services rendered by said providers to said patient.

27. The method according to claim 7, wherein said request is a prescription renewal request.

28. The method according to claim 7, wherein said request is selected from the group consisting of a request for referral for medical assessment, a request for referral for medical consultation, a request for referral for medical treatment, or a request for referral for testing.
